(19) United States
(12) Patent Application Publication
(10) Pub. No.: US 2015/0244535 A1
(43) Pub. Date: Aug. 27, 2015

(54) POWER OVER ETHERNET SUPERVISION

(71) Applicant: Telefonaktiebolaget L M Ericsson (publ), Stockholm (SE)

(72) Inventor: Ling Chen, Beijing (CN)

(73) Assignee: Telefonaktiebolaget L M Ericsson (publ), Stockholm (SE)

(21) Appl. No.: 14/372,081

(22) PCT Filed: Jan. 19, 2012
(86) PCT No.: PCT/CN2012/070563

§ 371 Date: Jul. 14, 2014

(51) Int. Cl. H04L 12/10

(52) U.S. Cl. CPC H04L 12/10; H04B 10/27

(57) ABSTRACT

A method in a power management module for supervision of a Power Sourcing Equipment, PSE, and a power management module adapted to supervise a PSE is provided. The PSE is adapted to provide power on an Ethernet cable. The power management module is connected to an Ethernet physical layer and a power source module within the PSE. The method comprises detecting a change in a power providing mode of the power source module. When the detected change indicates that the power source module has stopped to provide power, the method comprises switching off the Ethernet physical layer. When the detected change indicates that the power source module has started to provide power, the method comprises switching on the Ethernet physical layer.

### TECHNICAL FIELD

The present disclosure relates to power over Ethernet and in particular to supervision of a power over Ethernet function in a Power Source Equipment.

### BACKGROUND

Power over Ethernet, or PoE, technology describes a system to pass electrical power safely, along with data, on Ethernet cabling. IEEE has developed a standard for PoE which requires category 5 cable or higher for high power levels, but can operate with category 3 cable for low power levels. Power is supplied in common mode over two or more of the differential pairs of wires found in the Ethernet cables and comes from a power supply within a PoE-enabled networking device such as an Ethernet switch or can be injected into a cable run with a midspan power supply.

A Power Source Equipment, PSE, is a device such as a switch that provides power on the Ethernet cable. The PSE device may be implemented in different nodes or entities. For example, when the PSE device is a switch, it's called an endspan. Otherwise, if when the PSE device is an intermediary device between a non PoE capable switch and a PoE device, it's called a midspan.

A powered device is a device powered by a PSE and thus consumes energy. Examples include wireless access points, IP Phones, and IP cameras.

A powered device indicates that it is standards-compliant by having a 25 kΩ resistor between the powered pairs of the Ethernet cable. If the PSE detects a resistance that is too high or too low (including a short circuit), no power is applied. This protects devices that do not support PoE. An optional “power class” feature allows the powered device to indicate its power requirements by changing the sense resistance at higher voltages. To stay powered, the powered device must continuously use 5-10 mA for at least 60 ms with no more than 400 ms since last use or else it will be unpowered by the PSE.

In order to save energy, energy efficient Ethernet has been introduced, which is a set of enhancements to the twisted-pair and backplane Ethernet networking standards that will allow for less power consumption during periods of low data activity. The intention is to reduce power consumption by 50% or more, while retaining full compatibility with existing equipment.

The power reduction is accomplished in a few ways. In 100 Mbit/s, 1 Gbit/s and 10 Gbit/s speed data links, a lot of energy is used to keep the Ethernet physical layer transmitter chips on all the time. If they could be put into “sleep”, mode when no data is being sent that energy could be saved. By sending a low-power-idle (LPI) indication signal for a specified time, the transmit chips in the system can be turned off. LPI is sent periodically to refresh the sleep mode. When there is data to transmit, a normal idle signal is sent to wake the transmit system up before data is due to be sent. The data link is considered to be always operational, as the receiving signalling circuit remains active even when the transmit path is in sleep mode.

In addition, a new lower power mode has been added to 10Base-T (twisted pair cable), which reduces power supplies required for each interface. This is achieved when category 5 cables are used instead of category 3 cables. Category 3 cables require much greater receive equalization and hence more power is consumed in transmit mode.

In most cases, the PoE is the only power source of the powered device, e.g., Wi-Fi Access Point, VoIP telephone or Residential Gateway. Therefore the powered device is actually powered off completely in case the PoE does not provide power to the powered device. The powered device loses its only power source. The Ethernet physical layer, also called the Ethernet PHY, of the powered device is thus also powered off.

In the PSE, the Ethernet PHY detects the link down event and then works in link down mode. However, since the Ethernet interface is configured to be administratively enabled, the Ethernet PHY has to keep working, e.g. keep the receive function enabled to detect link up event, even though the link is down. In order for the Ethernet PHY to detect a link up event, the Ethernet PHY must be kept powered up. The Ethernet PHY in the PSE will thus consume power.

### SUMMARY

The object is to obviate at least some of the problems outlined above. In particular, it is an object to provide a method in a power management module for supervision of a Power Sourcing Equipment, PSE, and a power management module adapted to supervise a Power Sourcing Equipment, PSE, wherein the power management module detects a change in the provision of power from the PSE and switches the Ethernet physical layer of the PSE on or off accordingly. These objects and others may be obtained by providing a power management module and a method in a power management module according to the independent claims attached below.

According to an aspect, a method in a power management module for supervision of the PSE, which PSE is adapted to provide power on an Ethernet cable, is provided. The power management module is connected to an Ethernet physical layer and a power source module within the PSE. The method comprises detecting a change in a power providing mode of the power source module. When the detected change indicates that the power source module has stopped to provide power, the method comprises switching off the Ethernet physical layer. When the detected change indicates that the power source module has started to provide power, the method comprises switching on the Ethernet physical layer.

According to an aspect, a power management module adapted to supervise a PSE, which PSE is adapted to provide power on an Ethernet cable, is provided. The power management module is connected to an Ethernet physical layer and a power source module within the PSE. The power management module comprises a detection unit adapted to detect a change in a power providing mode of the power source module. The power management module also comprises a control unit adapted to switch off the Ethernet physical layer when the detected change indicates that the power source module has stopped to provide power, and to switch on the Ethernet physical layer when the detected change indicates that the power source module has started to provide power.

The power management module and the method therein have several advantages. In case a failure occurs resulting in the PSE no longer providing power to the powered device, the power management module switches off the Ethernet PHY of the PSE. This results in saving power as there is no reason to keep the power consuming Ethernet PHY switched on in case the PSE is not providing power to the powered device. Another advantage is that in case the PSE starts providing power to a powered device, the duration of powering up the Ethernet PHY by switching the Ethernet PHY on is very fast, in the range of milliseconds, as compared to the service bring up time of the powered device, which is in the range of seconds. This means that there is no service impact on the PSE.

### BRIEF DESCRIPTION OF DRAWINGS

Embodiments will now be described in more detail in relation to the accompanying drawings, in which:

FIG. 1 is a flowchart of a method in a power management module for supervision of a Power Sourcing Equipment according to an exemplifying embodiment.

FIG. 2a is a network architecture overview of a Passive Optical Network employing OMCI.

FIG. 2b is a signaling diagram illustrating an example when a PoE function is being disabled.

FIG. 3a is a block diagram of a power management module according to an exemplifying embodiment.

FIG. 3b is a block diagram of an example of a Power Source Equipment.

FIG. 3c is a block diagram of another example of a Power Source Equipment.

### DETAILED DESCRIPTION

Briefly described, exemplifying embodiments of a method in a power management module and a power management module for supervision of a Power Sourcing Equipment are provided. Further, a Power Sourcing Equipment comprising a power management module is provided. The power management module is adapted to supervise the Power Sourcing Equipment by switching on or switching off an Ethernet physical layer depending on the detection of a power source module having stopped or started to provide power.

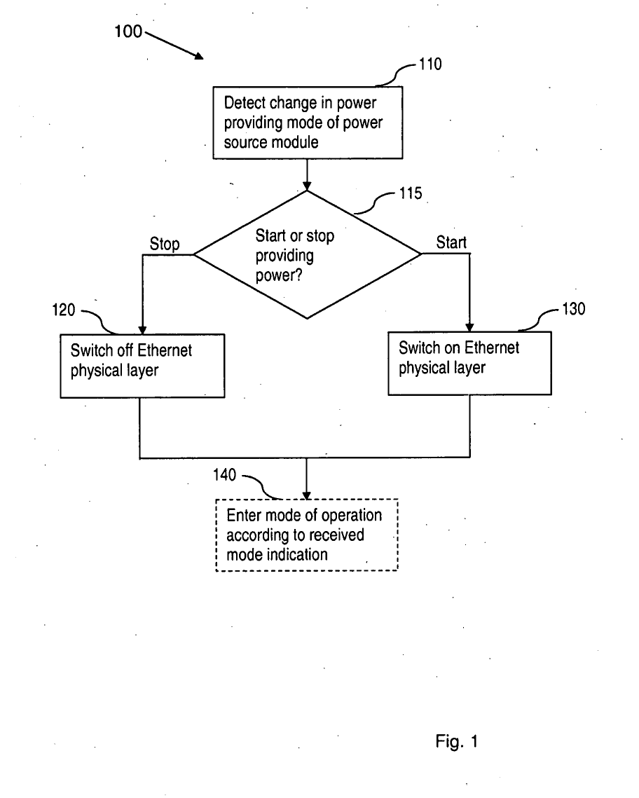

An exemplifying embodiment of a method in a power management module for supervision of a Power Sourcing Equipment, PSE, will now be described with reference to FIG. 1, which is a flowchart of a method in a power management module for supervision of the PSE according to an exemplifying embodiment.

The PSE is adapted to provide power on an Ethernet cable and the power management module is connected to an Ethernet physical layer and a power source module within the PSE.

FIG. 1 illustrates the method 100 comprising detecting 110 a change in a power providing mode of the power source module. When the detected change indicates that the power source module has stopped to provide power, the method comprises switching off 120 the Ethernet physical layer. When the detected change indicates that the power source module has started to provide power, the method comprises switching on 130 the Ethernet physical layer.

The power management module is connected to the power source module within the PSE and to the Ethernet physical layer comprised in the PSE. The PSE may have a powered device connected to it. If the PSE does not have a powered device connected to it, the PSE is connectable to a powered device. A powered device comprises an Ethernet physical layer, also called an Ethernet PHY, and a power receiver module. When the powered device is connected to the PSE, the Ethernet PHY of the PSE is connected to the Ethernet PHY of the powered device. Further, when the powered device is connected to the PSE, the power source module of the PSE is connected to the power receiver module of the powered device. By this latter connection, the powered device is powered by means of the PSE by the power source module of the PSE providing power to the power receiver module of the powered device.

If a powered device is currently connected to the PSE and either becomes disconnected from the PSE; or a failure occurs in the link connecting the power source module of the PSE and the power receiver module of the powered device; or any failure occurs in the powered device or the power source module of the PSE resulting in that the power source module of the PSE stops providing power, this is detected 110 by the power management module. If such a detection occurs, the method in the power management module comprises switching off 120 the Ethernet physical layer.

If the PSE currently does not have a powered device connected to it and either a powered device is connected to the PSE, or any failure causing the power source module to not provide power is remedied, resulting in the power source module starting to provide power, this is detected 110 by the power management module. If such a detection occurs, the method in the power management module comprises switching on 130 the Ethernet physical layer of the PSE.

The method has several advantages. In case a failure occurs resulting in the PSE no longer providing power to the powered device, the power management module switches off the Ethernet PHY of the PSE. This results in saving power as there is no reason to keep the power consuming Ethernet PHY switched on in case the PSE is not providing power to the powered device. Another advantage is that in case the PSE starts providing power to a powered device, the duration of powering up the Ethernet PHY by switching the Ethernet PHY on is very fast, in the range of milliseconds, as compared to the service bring up time of the powered device, which is in the range of seconds. This means that there is no service impact on the PSE.

According to an embodiment, the detection of the power source module starting to provide power comprises detecting a Powered Device, PD, connected to the PSE.

In case a powered device is connected to the PSE, the power source module of the PSE starts providing power to the power receiver module of the powered device. This is detected by the power management module, which then switches on the Ethernet PHY of the PSE as described above. This means that no action need to be taken to switch on the Ethernet PHY of the PSE as this will be done by the power management module. The Ethernet PHY of the PSE will not consume any unnecessary power as it will only be switched on once the power management module detects that the power source module of the PSE starts providing power.

According to yet an embodiment, the method further comprises entering 140 a mode of operation, being either enabled mode or disabled mode, according to a mode indication received from a network node.

In this example, it is possible to switch the power management module on or off corresponding to the power management module being in enabled mode or disabled mode respectively. Just as an example, for an operator, it may be desirable to have control over the power management module in order to switch it on or switch it off. In such a case, the operator accesses a network node which may be located in e.g. a central office, a management office centre or any other physical location from which the operator may control the power management module or the PSE. From this network node, the operator may send commands, notifications, instructions, indications and the like to at least the power management module of the PSE in order to control the operation mode (enabled/disabled) of the power management module. The operator may in another example send commands, notifications, instructions, indications and the like to the PSE and/or other units or modules comprised in the PSE.

According to still an embodiment, the disabled mode of the power management module causes the Ethernet physical layer and the power source module to operate independently of each other.

In this example, if the power management module is in the disabled mode, the power management module will not detect any possible change of the power source module starting or stopping to provide power. This means that the power management module will not be able to switch the Ethernet PHY on or off correspondingly. As a consequence, the Ethernet PHY will operate independently of the power source module and vice versa.

According to an embodiment, the indication from the network node is received on an Optical Network Termination, ONT, Management and Control Interface, OMCI.

According to yet an embodiment, the PSE is adapted for implementation in a Multi Dwelling Unit, MDU, in a Gigabit-capable Passive Optical Network, GPON.

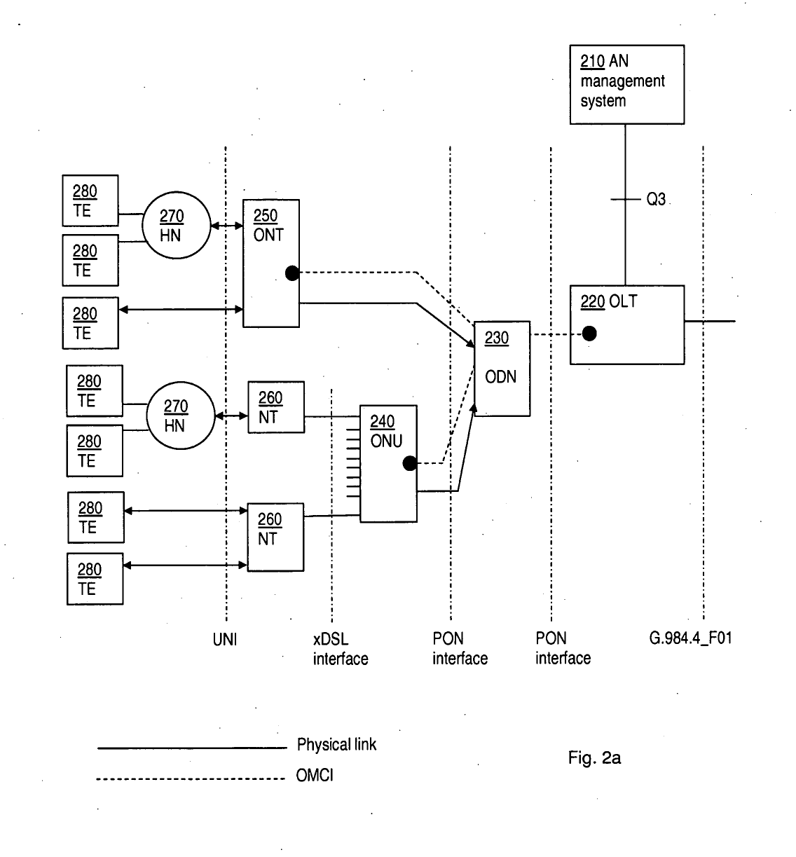

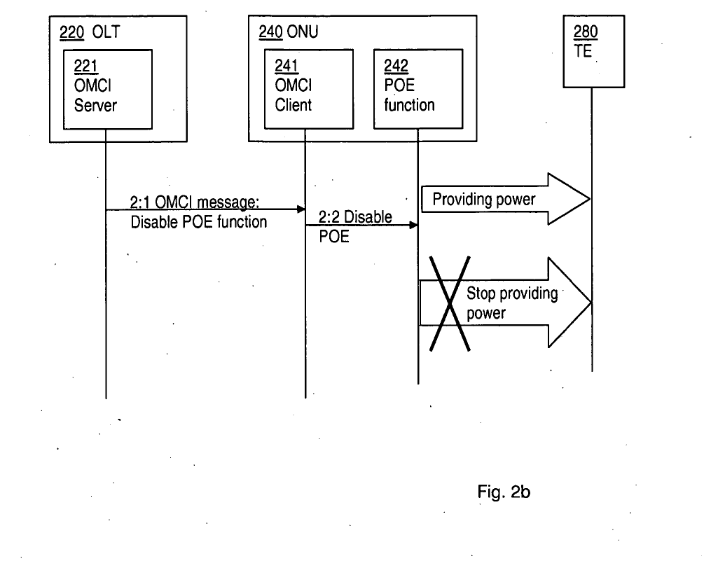

FIG. 2a is a network architecture overview of a Passive Optical Network employing OMCI. In FIG. 2a, the Optical Line Terminal, OLT, 220 is illustrated having an embedded OMCI management server, which is illustrated by a black circle. The Optical Network Unit, ONU, 240 and the Optical Network Terminal, ONT, 250 are illustrated having an embedded OMCI management client, which is also illustrated by a black circle.

OMCI is a message based protocol like Simple Network Management Protocol, SNMP. The basic information exchanging unit is referred to as a single OMCI message. The OMCI may be used to enable or disable the power source module of the PSE, which in FIG. 2a corresponds to the ONU 240 or the ONT 250. In this manner, an operator may remotely control the PSE/ONU 240/ONT 250, or in other word control the Power over Ethernet, PoE, function realised by or in the PSE/ONU 240/ONT 250.

FIG. 2b is a signaling diagram illustrating an example when a PoE function is being disabled. If an operator wants to disable the PoE function, i.e. switch off the power source module, the operator may use the OMCI management server 221 in the OLT 220 to send out 2:1 an OMCI message indicating to or instructing the OMCI management client 241 in the PSE/ONU 240/ONT 250 to disable the PoE function so that the power source module stops providing power. As an example, the OMCI message for disabling the PoE function may comprise the value “0” to indicate disabling the PoE function. When the OMCI management client 241 in the ONU 240 receives the OMCI message from the OMCI management server 221, the OMCI management client 241 instructs 2:2 the PoE function 242 to stop providing power.

Similarly, in case an operator would like enable the PoE function, i.e. switch on the power source module of the PSE/ONU 240/ONT 250, the operator may use the OMCI management server 221 in the OLT 220 to send out an OMCI message indicating to or instructing the OMCI management client 241 in the PSE/ONU 240/ONT 250 to enable the PoE function so that the power source module starts providing power. As an example, the OMCI message for enabling the PoE function may comprise the value “1” to indicate enabling the PoE function. When the OMCI management client 241 in the ONU 240 receives the OMCI message from the OMCI management server 221, the OMCI management client 241 instructs the PoE function 242 to start providing power.

According to an example, in line with the above two examples of the OMCI message having the values “0” or “1”, an OMCI message comprising the value “0” or the value “1” will further also disable the power management module. This means that the power management module will not supervise the PSE to detect any change in the operation mode of the power source module. Consequently, the commands or indications received via the OMCI will be responsible for the enabling and/or disabling of the PoE function. According to this example, the OMCI message may comprise another value, e.g. the value “2”, which will enable the power management module in the PSE to operate as has been described above. Merely as an example, the above described OMCI messages comprising the values “0”, “1” and “2” may be forwarded from the OMCI management client in the PSE/ONU 240/ONT 250 to the power management module. In case the OMCI message comprises the values “0” or “1”, the power management module will be disabled and will simply forward the OMCI message to the PoE function of the PSE/ONU 240/ONT 250. In case the OMCI message comprises the value “2”, the power management module will be enabled and operate as described above and may control the power source module or the PoE function of the PSE/ONU 240/ONT 250 e.g. by sending OMCI messages comprising the values “0” or “1” to the PoE function in order to disable or enable the power source module. Alternatively, other messages, protocols or interfaces may be used between the power management module and the power source module or the PoE function of the PSE/ONU 240/ONT 250.

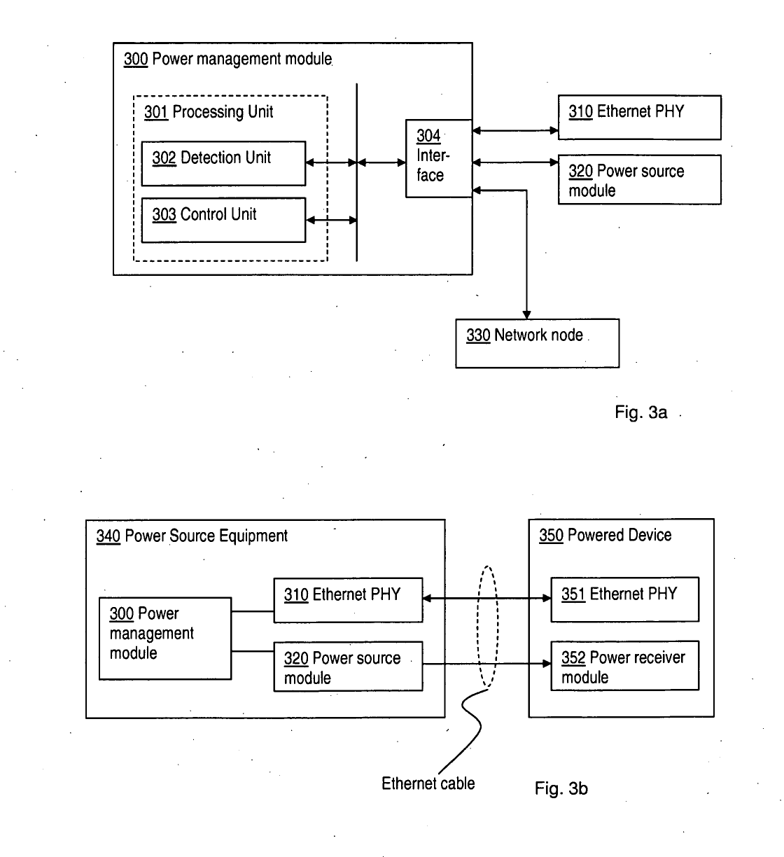

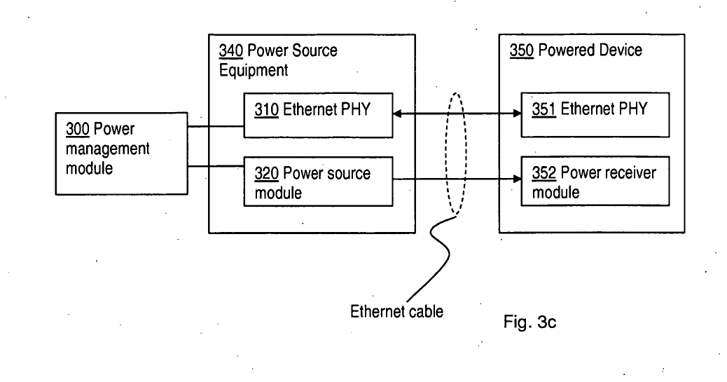

Embodiments herein also relate to a power management module adapted to supervise a PSE. Examples of such embodiments will now be described with reference to FIGS. 3a-3c. The power management module has the same objects, advantages and technical features as the method performed therein described above. Consequently, the power management module will be described in brief in order to avoid unnecessary repetition.

FIGS. 3a-3c illustrate a power management module 300 which is adapted to supervise a PSE 340. The PSE 340 is in turn adapted to provide power on an Ethernet cable. The power management module 300 is connected to an Ethernet physical layer 310 and a power source module 320 within the PSE 340. FIG. 3a illustrates the power management module 300 comprising a detection unit 302 adapted to detect a change in a power providing mode of the power source module 320. The power management module 300 also comprises a control unit 303 adapted to switch off the Ethernet physical layer 310 when the detected change indicates that the power source module 320 has stopped to provide power, and to switch on the Ethernet physical layer 310 when the detected change indicates that the power source module 320 has started to provide power.

The power management module has several advantages. In case a failure occurs resulting in the PSE no longer providing power to the powered device, the power management module switches off the Ethernet PHY of the PSE. This results in saving power as there is no reason to keep the power consuming Ethernet PHY switched on in case the PSE is not providing power to the powered device. Another advantage is that in case the PSE starts providing power to a powered device, the duration of powering up the Ethernet PHY by switching the Ethernet PHY on is very fast, in the range of milliseconds, as compared to the service bring up time of the powered device, which is in the range of seconds. This means that there is no service impact on the PSE.

FIG. 3a is an exemplifying block diagram illustrating the power management module 300. In this example, the power management module 300 comprises a processing unit 301 which in turn comprises dedicated units to perform the different actions. Further, FIG. 3a illustrates the power management module 300 comprising an interface 304 through which the power management module 300 may communicate and/or interact with other entities, e.g. the power source module 320, the Ethernet physical layer 310 and also a network node 330. It shall be pointed out that FIG. 3a is merely an illustrative example and the power management module 300 may e.g. comprise several separate interfaces and the processing unit may not comprise any dedicated units or may comprise other dedicated units to perform the actions or method steps of the power management module 300.

According to an embodiment, the detection unit 302 is adapted to detect a Powered Device, PD, 350 connected to the PSE 340 in order to detect the change in a power providing mode of the power source module 320.

According to yet an embodiment, the control unit 303 is further adapted to receive a mode indication received from a network node 330 and to enable or disable the power management module 300 in accordance to the received mode indication.

According to still an embodiment, the power management module 300 being disabled, causes the Ethernet physical layer 310 and the power source module 320 to operate independently of each other.

According to an embodiment, the indication from the network node 330 is received on an Optical Network Termination, ONT, Management and Control Interface, OMCI.

According to yet an embodiment, the PSE 340 is adapted for implementation in a Multi Dwelling Unit, MDU, in a Gigabit-capable Passive Optical Network, GPON.

According to still an embodiment, the power management module 300 is adapted to be integrated within the PSE 340. Such a technical solution is illustrated in FIG. 3b.

According to yet an embodiment, the power management module 300 is adapted to be connectable to the PSE 340. Such a technical solution is illustrated in FIG. 3c.

Embodiments herein also relate to a Power Sourcing Equipment, PSE, 340 comprising a power management module 300, the power management module 300 having been described above.

It should be noted that FIG. 3a merely illustrates various functional units in the power management module in a logical sense. The functions in practice may be implemented using any suitable software and hardware means/circuits etc. Thus, the embodiments are generally not limited to the shown structures of the power management module and the functional units. Hence, the previously described exemplary embodiments may be realised in many ways. For example, one embodiment includes a computer-readable medium having instructions stored thereon that are executable by the processing unit for executing the method steps in the power management module. The instructions executable by the computing system and stored on the computer-readable medium perform the method steps of the present invention as set forth in the claims.

FIG. 3a schematically shows an embodiment of a power management module 300. Comprised in the power management module 300 are here a processing unit 301, e.g. with a DSP (Digital Signal Processor). The processing unit 301 may be a single unit or a plurality of units to perform different actions of procedures described herein. The power management module 300 may also comprise an input unit for receiving signals from other entities, and an output unit for providing signal(s) to other entities. The input unit and the output unit may be arranged as an integrated entity or as illustrated in the example of FIG. 3a, as one or more interfaces 304.

Furthermore, the power management module 300 comprises at least one computer program product in the form of a non-volatile memory, e.g. an EEPROM (Electrically Erasable Programmable Read-Only Memory), a flash memory and a hard drive. The computer program product comprises a computer program, which comprises code means, which when executed in the processing unit 301 in the power management module 300 causes the power management module 300 to perform the actions e.g. of the procedure described earlier in conjunction with FIG. 1.

The computer program may be configured as a computer program code structured in computer program modules. Hence, in an exemplifying embodiment, the code means in the computer program of the power management module 300 comprises a detection unit for detecting a change in a power providing mode of the power source module 320. The computer program further comprises a control unit for switch the Ethernet physical layer 310 on or off according to the detected change in the power providing mode of the power source module 320.

The computer program modules could essentially perform the actions of the flow illustrated in FIG. 1, to emulate the power management module 300. In other words, when the different computer program modules are executed in the processing unit 301, they may correspond to the units 302 and 303 of FIG. 3a.

Although the code means in the embodiment disclosed above in conjunction with FIG. 3a are implemented as computer program modules which when executed in the processing unit causes the power management module 300 to perform the actions described above in the conjunction with figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the power management module 300.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method in a power management module for supervision of a Power Sourcing Equipment (PSE) operative to provide power on an Ethernet cable, the power management module being connected to an Ethernet physical layer and a power source module within the PSE, the method comprising:
detecting a change in a power providing mode of the power source module;
when the detected change indicates that the power source module has stopped to provide power, the method comprises switching off the Ethernet physical layer; and
when the detected change indicates that the power source module has started to provide power, the method comprises switching on the Ethernet physical layer.

2. A method according to claim 1, wherein the detection of the power source module starting to provide power comprises detecting a Powered Device (PD) connected to the PSE.

3. A method according to claim 1, wherein the method further comprises entering a mode of operation, being either enabled mode or disabled mode, according to a mode indication received from a network node.

4. A method according to claim 3, wherein the disabled mode of the power management module causes the Ethernet physical layer and the power source module to operate independently of each other.

5. A method according to claim 3, wherein the mode indication from the network node is received on an Optical Network Termination (ONT) Management and Control Interface (OMCI).

6. A method according to claim 1, wherein the PSE is operative to implement in a Multi Dwelling Unit (MDU) in a Gigabit-capable Passive Optical Network (GPON).

7. A power management module operative to supervise a Power Sourcing Equipment (PSE) which is operative to provide power on an Ethernet cable, the power management module being connected to an Ethernet physical layer and a power source module within the PSE, the power management module comprising:
a detection unit operative to detect a change in a power providing mode of the power source module; and
a control unit operative to switch off the Ethernet physical layer when the detected change indicates that the power source module has stopped to provide power, and to switch on the Ethernet physical layer when the detected change indicates that the power source module has started to provide power.

8. A power management module according to claim 7, wherein the detection unit is operative to detect a Powered Device (PD) connected to the PSE in order to detect the change in a power providing mode of the power source module.

9. A power management module according to claim 7, wherein the control unit is further operative to receive a mode indication received from a network node and to enable or disable the power management module in accordance to the received mode indication.

10. A power management module according to claim 9, wherein the power management module being disabled, causes the Ethernet physical layer and the power source module to operate independently of each other.

11. A power management module according to claim 9, wherein the mode indication from the network node is received on an Optical Network Termination (ONT) Management and Control Interface (OMCI).

12. A power management module according claim 7, wherein the PSE is operative to implementation in a Multi Dwelling Unit (MDU) in a Gigabit-capable Passive Optical Network (GPON).

13. A power management module according to claim 7, wherein the power management module is operative to be integrated within the PSE.

14. A power management module according to claim 7, wherein the power management module is operative to be connectable to the PSE.

15. A Power Sourcing Equipment (PSE) comprising a power management module according to claim 7.

16. A non-transitory computer-readable medium having instructions stored within, which when executed by a processing unit, cause the processing unit to:
detect a change in a power providing mode of a power source module within the Power Sourcing Equipment PSE operative to provide power on an Ethernet cable;
when the detected change indicates that the power source module has stopped to provide power, switch off an Ethernet physical layer connected to a power management module that supervises the PSE; and
when the detected change indicates that the power source module has started to provide power, switch on the Ethernet physical layer.

17. The non-transitory computer-readable medium according to claim 16, wherein the detection of the power source module starting to provide power comprises detecting a Powered Device (PD) connected to the PSE.

18. The non-transitory computer-readable medium according to claim 16, wherein the method further comprises entering a mode of operation, being either enabled mode or disabled mode, according to a mode indication received from a network node.

19. The non-transitory computer-readable medium according to claim 18, wherein the disabled mode of the power management module causes the Ethernet physical layer and the power source module to operate independently of each other.

20. The non-transitory computer-readable medium according to claim 18, wherein the mode indication from the network node is received on an Optical Network Termination (ONT) Management and Control Interface (OMCI).
